(19) United States
(12) Patent Application Publication
(10) Pub. No.: US 2012/0216965 A1
(43) Pub. Date: Aug. 30, 2012

(54) WINDOW ELEMENT FOR A SIDE DOOR, IN PARTICULAR A REAR SIDE DOOR, OF A MOTOR VEHICLE

(76) Inventors: Luciano Castagnola, Esslingen-Mettingen (DE); Eckbert Link, Schwieberdingen (DE); Thomas Mück, Gemmrigheim (DE)

(21) Appl. No.: 13/404,296

(22) Filed: Feb. 24, 2012

(30) Foreign Application Priority Data
Feb. 24, 2011 (DE) 10 2011 012 256.7

(51) Int. Cl. B60J 1/17

(52) U.S. Cl. 160/90; 49/404

(57) ABSTRACT

A window element for a side door of a vehicle has at least one frame element including a guide and defining interconnected first and further window portals. A side pane is guidable by the frame element along the guide between a position closing the window portal and at least one position releasing the first window portal. The window element has a window web by which a frame part of the frame element is covered, at least in some regions. The frame part spatially separates the first and further window portals, and has a side pane held rigidly on the frame element. The further window portal is covered by the side pane that is held on the frame element, at least in some regions, with at least one plastics material, via which a screwed connection to the window web and/or to a door carcass of the side door is formable.

The invention relates to a window element for a side door, in particular a rear side door, of a motor vehicle according to claim 1.

It is known from the series production of motor vehicles that side doors, in particular of multi-purpose vehicles, comprise a first window portal and a second window portal connecting to said first window portal. In order to provide the window portals with a respective side pane, a frame element is fastened on a carcass of the side door. Further, a side pane assigned to one of the window portals is fastened on the carcass and is immobile relative to the carcass. In addition, cover elements are provided which cover, at least in some regions, frame parts of the frame element and/or vehicle pillars of the body of the motor vehicle so as to positively influence the visual appearance of the side door. When fastening and installing the frame element, the side pane, the cover elements and any further component, there may be tolerances, the compensation of which requires a time-consuming and therefore cost-intensive installation process, and which may only be possible with great difficulty.

The object of the present invention is therefore to provide a window element for a side door, in particular a rear side door, of a motor vehicle, said window element being easy to install.

This object is achieved by a window element for a side door, in particular a rear side door, of a motor vehicle having the features of claim 1. Advantageous embodiments containing expedient and non-trivial developments of the invention are disclosed in the other claims.

A window element according to the invention for a side door, in particular a rear side door, of a motor vehicle, in particular of a passenger vehicle, has at least one frame element comprising a guide, said frame element defining, at least in some regions, a first window portal and a further window portal, connecting to said first window portal, of the side door. A side pane can be guided, by means of the frame element, along the guide between a position closing the window portal and at least one position releasing the first window portal, at least in some regions. The window element according to the invention further has a window web, by means of which a frame part of the frame element is covered, at least in some regions, said frame part spatially separating the first and further window portals from one another, in particular in the longitudinal direction of the vehicle.

The window element according to the invention further has a side pane held rigidly on the frame element, the further window portal being covered by means of said side pane. The side pane held on the frame element is provided, and in particular is injected, at least in some regions, with at least one plastics material, via which a screwed connection to the window web and/or to a door carcass of the door can be formed. The side pane held on the frame element is injected in an edge region for example with the at least one plastics material, in particular by an injection moulding process. At least one fastening means and/or at least one corresponding functional structure is advantageously formed by the plastics material, via which the window web and possibly a cover element assigned to a vehicle pillar, in particular a B-pillar or a C-pillar, is fastened on the frame element.

For example, the fastening means or functional structure may be at least one clip element, by means of which the window web and/or the cover element is clipped to the frame element by the at least one plastics material. As a result of this clipping process, the window web and/or the cover element is/are latched to the frame element, wherein this latching process can be carried out in a simple, quick and therefore cost-effective manner. Owing to the described injection with the plastics material of the side pane held on the frame element and the option of a screwed connection, formed by the plastics material, between said plastics material and the window web and/or the door carcass and owing to the option of fastening the cover element on the frame element via the plastics material, positional tolerances of the window web and possibly of the cover element relative to the side pane held on the frame element are avoided. The window element can thus be installed in a simplified and therefore more time-efficient and cost-effective manner. Additional and time-consuming and therefore cost-intensive installation procedures for tolerance compensation are not provided and are not necessary. The avoidance of positional tolerances is provided in particular by the fact that connection geometries and the design of the screwing and fastening options are produced from one tool, that is to say are produced by means of the same tool by the plastics material.

The window element according to the invention further comprises a particularly low number of parts and therefore a particularly low number of installation procedures, which keeps the installation costs and therefore the overall costs of the window element and therefore of the entire motor vehicle low.

In an advantageous embodiment of the invention the side pane held on the frame element is provided, in particular is injected at least in part, with the at least one plastics material and with at least one further plastics material. The further plastics material is softer than the first at least one plastics material. The described option for screwing of the plastics material and therefore of the frame element to the window web and/or to the door carcass, and possibly also the fastening means for fastening the window web on the frame element is/are formed by the harder of the plastics materials. A sealing function is preferably provided by the softer of the plastics materials, thus sealing the frame element with respect to the door carcass and/or other components, in particular sheet metal components, of the side door.

Furthermore, a connection to the guide, which is formed for example as a window runner, may be provided by the softer of the plastics materials. A particularly high functional integration of the window element according to the invention is thus created, this window element therefore having a small number of parts and requiring a particularly low level of installation effort. This is accompanied by particularly low installation costs and therefore by particularly low overall costs.

In a further embodiment the cover element and/or the window web may be formed by a “two-component injection” of the side pane held on the frame element. In this case the side pane held on the frame element is provided with a two-component plastics material which forms the cover element and the window web as well as the described screwing option and possibly the fastening means. This keeps the number of the parts of the window element low. The formation however, in particular of the cover element, as a separate individual part affords the advantage that it can cover, in the form of theft protection, a screwed connection of the frame element to the door carcass and can ensure a positive visual appearance of the side door.

In a further embodiment of the invention, at least the side pane held on the frame element, the window web and the frame element are assembled to form a modular component. An adding of tolerances, in particular in the longitudinal direction of the vehicle, is avoided by this modular component. Further, this modular component enables a particularly simple and therefore quick and cost-effective installation. The assembly of the frame part, the window web and the side pane held on the frame element to form the modular component also makes it possible to produce the modular component at least substantially in parallel, in terms of time, with the manufacture of the side door and to preassemble it and then deliver it in the preassembled state as an assembly, for example to a manufacturing line of the motor vehicle. The modular component can then be installed, as an assembly, on the side door, in particular the door carcass, in a quick and cost-effective manner. As a result of this assembly process to form the modular component, time-consuming and costly installation procedures for compensation of tolerances are not provided and are unnecessary.

Further advantages, features and details of the invention will emerge from the following description of a preferred embodiment, given with reference to the drawing. The features and combinations of features mentioned in the description above as well as the features and combinations of features mentioned hereinafter in the description of the figures and/or shown alone in the figures can not only be used in the combination stated in each instance, but also in other combinations or alone, without departing from the scope of the invention.

In the drawing:

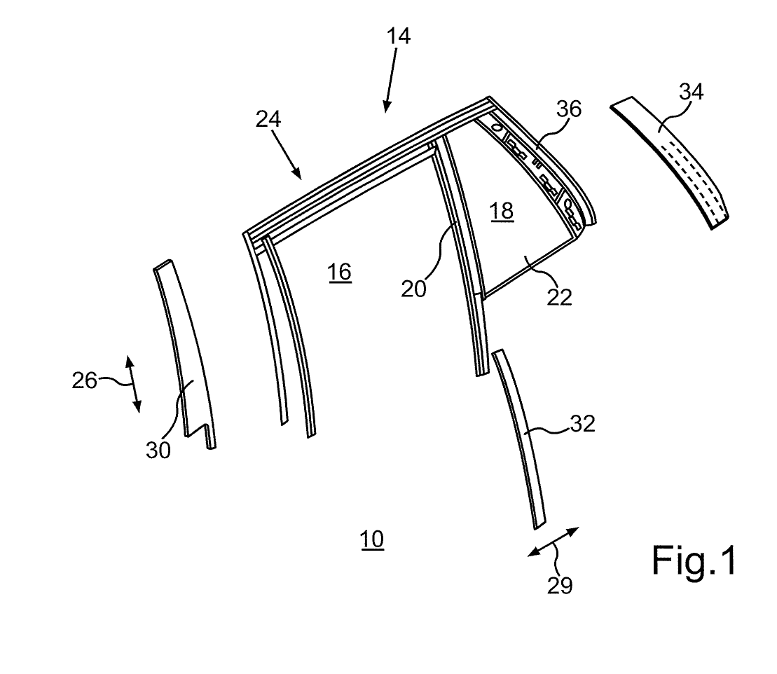

FIG. 1 shows a schematic and perspective exploded view of an element for a rear side door of a passenger vehicle, with a frame element defining, in part, a first window portal and second, further window portal, connecting to said first window portal at the rear end, a triangular pane assigned to the further window portal and held on the frame element, a window web to be held on the frame element, a screening panel assigned to a B-pillar of the passenger vehicle, and a screening panel assigned to a C-pillar of the passenger vehicle;

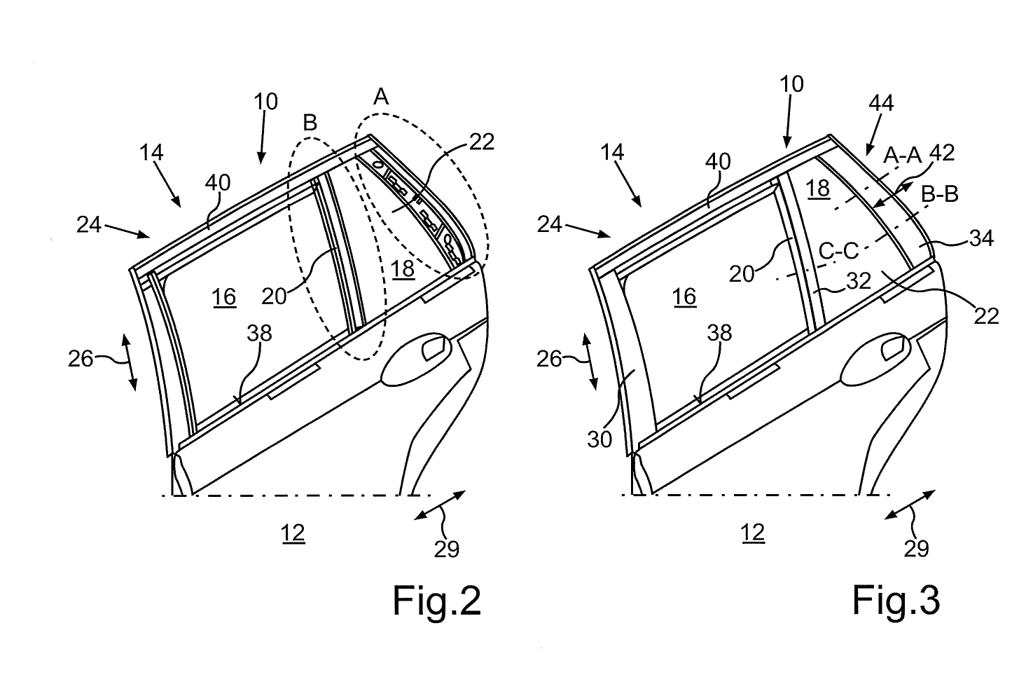

FIG. 2 shows a schematic perspective view of a detail of rear side door of a passenger vehicle with the frame element and the triangular pane according to FIG. 1;

FIG. 3 shows a schematic perspective view of a detail of the side door according to FIG. 2 with the window element according to FIG. 1;

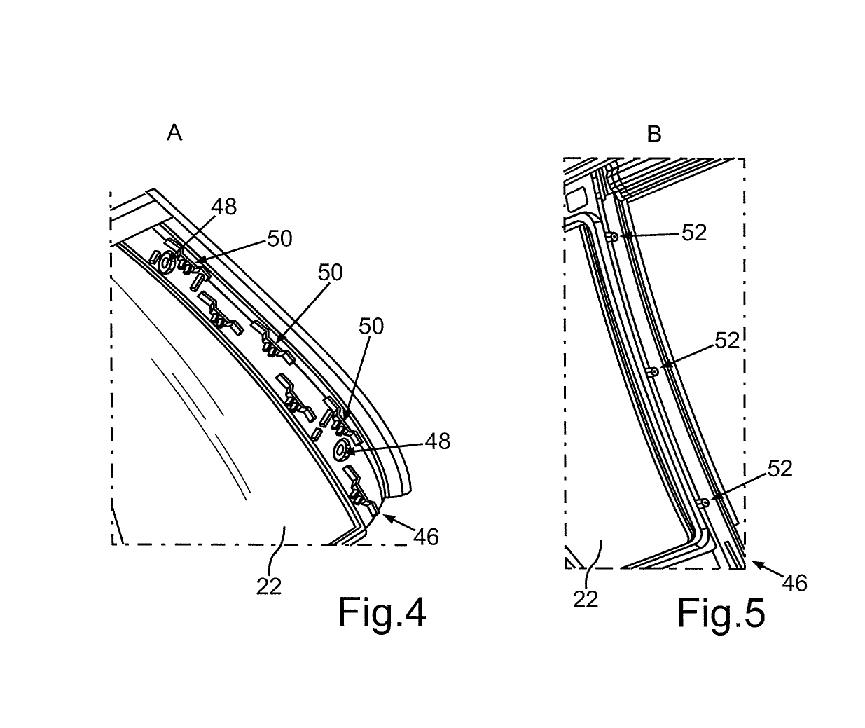

FIG. 4 shows a schematic perspective view of a detail of the side door according to FIG. 2;

FIG. 5 shows a schematic perspective view of a detail of the side door according to FIG. 2;

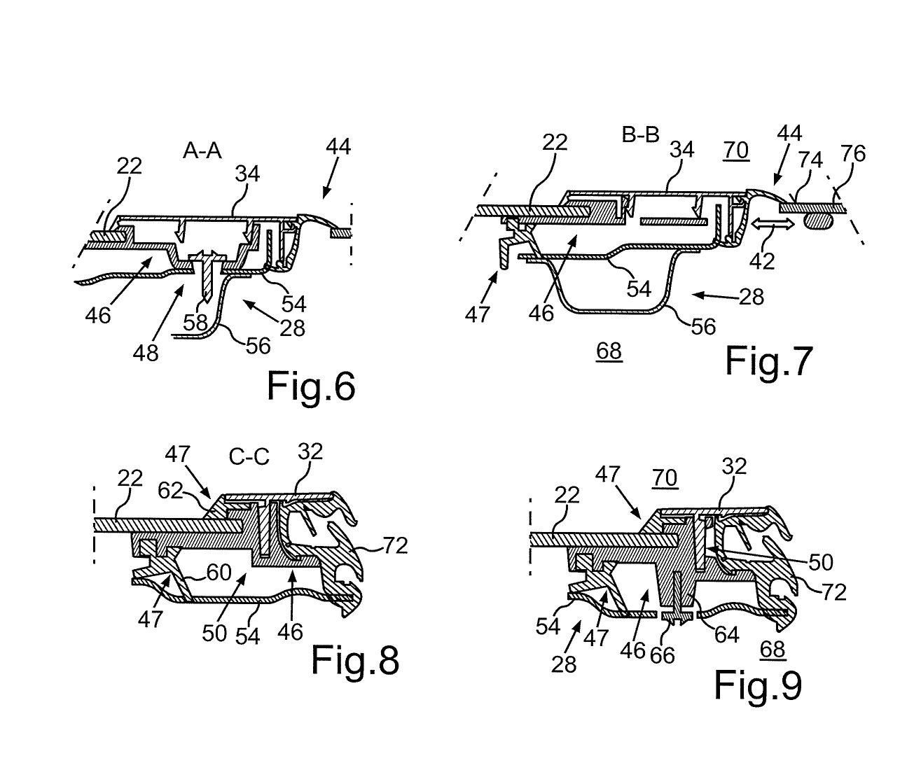

FIG. 6 shows a schematic cross-sectional view of a detail of the side door according to FIG. 3 along a sectional line A-A shown in FIG. 3;

FIG. 7 shows a schematic cross-sectional view of a detail of the side door according to FIG. 3 along a sectional line B-B shown in FIG. 3;

FIG. 8 shows a schematic cross-sectional view of a detail of the side door according to FIG. 3 along a sectional line C-C shown in FIG. 3; and

FIG. 9 shows a further cross-sectional view of a detail of the side door according to FIG. 8.

FIG. 1 shows a window element 10 for a side door 12 (FIG. 2) for a passenger vehicle designed as a multi-purpose vehicle. The side door 12 is a rear side door in the longitudinal direction of the vehicle and is referred to as a back door and is arranged behind a front door in the longitudinal direction of the vehicle.

The window element 10 comprises a frame element 14 which defines, in part, a first window portal 16 and a window portal 18, connecting at the rear end to the window portal in the longitudinal direction of the vehicle in the direction of an arrow 29. The frame element 14 comprises a frame part 20, which spatially separates the window portals 16 and 18 from one another in the longitudinal direction of the vehicle in the direction of the arrow 29.

In addition, the frame element 14 has a triangular pane 22, which covers the window portal 18 and which is held rigidly on the frame element 14. This means that the triangular pane 22 is a fixed side pane which is immobile relative to the frame element 14 and, on the whole, to the side door 12.

The frame element 14 additionally has a “window runner” 24, which provides a guide. The guide is used to guide a side pane which is assigned to the window portal 16 and which is movable along the guide of the window runner 24 in the vertical direction of the vehicle in the direction of an arrow 26 between a position releasing the window portal 16, at least in some regions, and by contrast at least one position closing the window portal 16.

When installing the side door 12, the frame element 14 with the window runner 24 and the triangular pane 22 is fitted onto a joint line on a door carcass 28 (FIG. 6), that is to say is oriented relative to a screening panel 30, and is screwed to the door carcass 28, for example by two screws externally and three screws internally. No other adjustment procedures are carried out.

The screening panel 30 is assigned to a B-pillar of the body of the passenger vehicle and is used to cover the B-pillar, at least in some regions. The screening panel 30 is installed on the B-pillar, is oriented and is fastened on the carcass of the body by three screws, the window element 10 then being installed.

The window element 10 further comprises a window web 32 which covers the frame part 20, at least in some regions, and which is fastened on the frame element 14 by clipping the window web 32 to the frame element 14. No alignment is required.

In addition, the window element 10 comprises a screening panel 34 which is clipped to the installed frame element 14. In this case, too, there is no further alignment. The screening panel 34 is assigned to a C-pillar of the body of the passenger vehicle and is used to cover the C-pillar and a frame part 36 of the frame element 14, at least in some regions, and thus ensures a good visual appearance of the frame element 14. FIG. 1 provides an overview of individual parts above a stepped edge 38 (FIG. 2), in particular for guiding the side pane assigned to the window portal 16.

FIGS. 2 and 3 illustrate the described installation procedure of the window element 10 and of the screening panel 30. The frame element 14 is first preassembled with the window runner 24 and the triangular pane 22, wherein in particular the window runner 24 is aligned with a screening panel 40. The window runner 24 is then installed from above in an end position. The triangular pane 22 is fastened on the window web 32 by three screws in corresponding slots, there being no alignment. Further, the triangular pane 22 is fastened at the rear on the door carcass 28 by two screws via corresponding slots, there also being no alignment.

It can be inferred from FIG. 3 that the screening panel 30 is fastened with three screws and that there is no alignment. Lastly, the window web 32 is clipped on. The screening panel 34 is likewise clipped to the frame element 14. A compensation of positional tolerances indicated by a directional arrow 42 in FIG. 3 is carried out by a joining lip 44 at a rear door joint. Owing to the assembly of the frame element 14, the window web 32 and the triangular pane 22 to form a modular component, positional tolerances of the window web 32 and of the rear screening panel 34 relative to the triangular pane 22 are avoided.

FIG. 4 shows the side door 12 according to FIG. 2 in a marked area A. As can be inferred from FIG. 4, the triangular pane 22 is injected in the edge regions of the triangular pane 22 with a first plastics material 46. Screwing means 48 are formed by the plastics material 46, these possibly being screw domes with an inner thread or through-openings for example. Owing to these screw means 48, the triangular pane 22 can be screwed to the door carcass 28 from the outside, whereby the frame element 14 can be screwed to the door carcass 28. Further, clip elements 50 are formed by the plastics material 46, it being possible to clip on and guide the rear screening panel 34 by means of said clip elements.

FIG. 5 shows the side door 12 according to FIG. 2 in a marked area B. In the area B, too, the triangular pane 22 is injected in the edge regions with the plastics material 46. Screwing means 52 are also formed in the area B by the plastics material 46, it being possible to screw the window web 32 to the frame element 14 by means of said screwing means.

FIGS. 6 and 9 show the injection of the triangular pane 22 with the plastics material 46 and with a further plastics material 47, with which the triangular pane 22 is also provided. The plastics material 46 is harder than the plastics material 47. As can be inferred in particular from FIG. 6, the screw means 48 and the clip elements 50 are formed by the harder plastics material 46 so that the plastics material 46 and, via this, the triangular pane 22 can be fastened particularly rigidly on the door carcass 28. The door carcass 28 has a first sheet metal component 54 and a further sheet metal component 56 connected, for example welded, to said first sheet metal component. A screw 58 can be seen in FIG. 6, by means of which the plastics material 46 is screwed to the door carcass 28 via the screw means 48 formed as a through-opening. Further, the rear screening panel 34 assigned to the C-pillar is clipped to the frame element 14 via the hard or harder plastics material 46.

As can be inferred in particular from FIG. 7, a sealing function is provided by the softer or soft plastics material 47, whereby the frame element 14 or the triangular pane 22 is sealed with respect to the door carcass 28. For this purpose for example, a sealing lip 60 is formed by the softer plastics material 47 and rests against the sheet metal component 54.

The harder plastics material 46 is also used, as can be inferred in particular from FIG. 8, to fasten the window web 32 to the frame element 14 by clipping the window web 32 to the harder plastics material 46. A further sealing lip 62 is formed by the softer plastics material 47 and rests against the window web 32 and the triangular pane 22, and performs a sealing function.

FIG. 9 shows a screw dome 64 of the screw means 48, said screw dome being formed by the harder plastics material 46 and having an inner thread. A screw 66 is screwed into the screw dome 64 so that the triangular pane 22 can be fastened on the door carcass 28 or to the sheet metal component 54 from an inner face 68 of the side door 12, and therefore of the passenger vehicle, via the screw dome 64. In addition to the inner face 68, an outer face 70 of the side door 12 or of the passenger vehicle can be seen.

In FIGS. 6 and 7 it can be seen that the joining lip 44 is held on the screening panel 34. The joining lip 44 grips the screening panel 34 from behind for this purpose and is thus clipped thereto.

As can be inferred from FIGS. 8 and 9, the harder plastics material 46 is also used to hold a sealing and guiding element 72 which guides and seals the side pane assigned to the window portal 16. No moisture can thus infiltrate from the outer face 70 to the inner face 68, and therefore into the interior of the passenger vehicle.

The directional arrow 42 is shown in FIG. 7 and indicates the tolerance compensation by the joining lip 44 assigned to the C-pillar. The tolerance compensation is carried out by displacement over a sealing face 74 of a rear side pane 76 in the direction of the arrow 42.

One of the clip elements 50 can also be seen in FIGS. 8 and 9 and is formed by the harder plastics material 46 and clips the window web 32 to the frame element 14.

1. A window element for a side door, in particular a rear side door, of a motor vehicle, having at least one frame element comprising a guide and defining, at least in some regions, a first window portal and a further window portal, connecting to said first window portal, a side pane being guidable by means of said frame element along the guide between a position closing the window portal and at least one position releasing the first window portal, at least over regions, said window element having a window web, by means of which a frame part of the frame element is covered, at least in some regions, said frame part spatially separating the first and further window portals from one another, and having a side pane held rigidly on the frame element, the further window portal being covered by means of said side pane, wherein the side pane held on the frame element is provided, at least in some regions, with at least one plastics material, via which a screwed connection to the window web and/or to a door carcass of the side door is formable.

2. The window element according to claim 1, wherein at least one screw is formed by the plastics material to form the screwed connection.

3. The window element according to claim 1, wherein the plastics material is used for connecting the at least one further fastener to fasten the window web and/or a cover element on or to the frame element.

4. The window element according to claim 3, wherein the cover element fastened on the frame element via the fastener is formed as a screening panel assigned to a vehicle pillar of the motor vehicle.

5. The window element according to claim 1, wherein the side pane held on the frame element is provided at least in some regions, with a further plastics material compared to the at least one plastics material, at least one sealing element being formed by the further plastics material for sealing the window element with respect to a carcass of the side door.

6. The window element according to claim 1, wherein the side pane held on the frame element, the window web and the frame element are assembled to form a modular component.

7. The window element according to claim 2, wherein the at least one screw has an outer thread and/or an inner thread and/or a screw dome formed by the plastics material to form the screwed connection.

8. The window element according to claim 3, wherein the at least one further fastener is a clip element that clips the window web and/or a cover element to the frame element.

9. The window element according to claim 4, wherein the vehicle pillar is a C-pillar of the motor vehicle.

10. The window element according to claim 5, wherein the side pane held on the frame element is provided injected, at least in some regions, with the further plastics material.
